(19) United States
(12) Patent Application Publication
(10) Pub. No.: US 2020/0274417 A1
(43) Pub. Date: Aug. 27, 2020

(54) SERVO AIR-KOOL SYSTEM

(71) Applicant: Kimberly-Clark Worldwide, Inc., Neenah, WI (US)

(72) Inventors: HoHyoung Koo, Taejon-Si (KR); ChiHoon Kang, Taejon-Si (KR); BongSu Kang, Taejon-Si (KR)

(21) Appl. No.: 16/643,681

(22) PCT Filed: Sep. 29, 2017
(86) PCT No.: PCT/US17/54392

§ 371 Date: Mar. 2, 2020

(51) Int. Cl. H02K 5/18; H02K 9/14; H02K 9/06; H02K 15/14

(52) U.S. Cl. CPC H02K 5/18; H02K 15/14; H02K 9/06; H02K 9/14

(57) ABSTRACT

The present disclosure provides for an apparatus to improve cooling of an electrical motor which comprises a boltless and finned metal body that covers the electrical motor wherein the metal body includes: a safety guard; an axial fan; an air cone; and an air tunnel; further wherein the temperature of the electric motor is maintained at a steady state, for example, from about 55 degrees Celsius to about 75 degrees Celsius so as not to overheat the electric motor. The present disclosure also provides for methods of making the apparatus as well.

### TECHNICAL FIELD

The present disclosure provides an economical and reliable means for cooling an apparatus using air as the cooling medium. More specifically, the present disclosure discloses an easy to install and removable cooling apparatus for encasing servomotor equipment wherein the apparatus maintains a steady temperature so as not to overheat the servomotor equipment.

### BACKGROUND OF THE DISCLOSURE

There are two primary drive type machines that are used for making diapers and pants. One type is a mechanical line shaft and another type is a servo motor type.

A mechanical line shaft machine includes a line shaft which is the rotating shaft part of a system of mechanical couplings between the power source in a factory and the machines that do work. These rotating shafts transmit mechanical energy throughout the factory, and are interconnected to each other and to machines using various systems of pulleys, gears, and other mechanical methods. The servo motor drive machine, on the other hand, is a special electronic amplifier used to power electric servos (also known as a servomechanism). A servo drive monitors the feedback signal from the servomechanism and continually adjusts for deviation from expected behavior.

The main advantage of using servo motor drive machines over traditional mechanical line shaft machines is the addition of motor feedback. This feedback can be used to detect unwanted motion, or to ensure the accuracy of the commanded motion. The feedback is generally provided by an encoder. Overall, servomotors have a better life cycle than mechanical line shaft machines.

Because of the high speeds and process changes involved with servo motor drive machines high motor temperatures become a problem. The temperatures observed may reach over 100 C and as a result motor malfunctions frequently occur. There have been several solutions to cool the heated servo motors before but these solutions to cool the heated servo motors have not been fully successful. These solutions have included using sealed liquid cooling systems, elaborate pumping means for circulating coolant within totally enclosed machines, and means for circulating ambient air through and about machines having open and drip proof housing. These solutions unfortunately have problems due to either a limited installation area, low efficiency with high energy consumption and/or expensive costs. Therefore, there is a need for a more efficient system to maintain a stable servomotor temperature without overheating and thus causing manufacturing downtime.

### SUMMARY OF THE DISCLOSURE

The present disclosure describes a cooling apparatus to improve the cooling of an electric motor such as a servomotor and thereby decreasing damage due to high thermal operation. Such servomotors can be used, for example, in the day-to-day use in diaper and pant machines and the decreased running temperature increases motor longevity, which reduces costs related to both motor replacement and machine downtime.

More specifically, the current disclosure describes a cooling apparatus that channels air toward an electrical motor. The apparatus comprises a boltless and finned body, made preferably from aluminum, or other materials that have high heat conductivity, configured to cover the motor. The apparatus's design to distribute the air to remove heat from the motor is capable of maintaining reduced motor operating temperatures. For example, servo motors made by Allen-Bradley having manufacturer numbers MPL-B420P-MJ72AA, MPL-B520K-MJ72AA, MPL-B540K-MJ72AA, MPL-B580J-MJ72AA, MPL-B860D-MJ72AA, MPL-B980D-MJ72AA have general operating temperatures between about 80 degrees C. and 105 degrees C. when being run at about 80 percent RPM (rate per minute for the motor rotation). However, when cooled with the cooling apparatus of the present disclosure, such exemplary motors were seen to run at between about 55 degrees C. and about 75 degrees C. when run within the above RPM percent.

In a first embodiment, the present disclosure discloses a cooling apparatus configured to cool an electrical motor the cooling apparatus comprising:
an apparatus housing extending between a proximal end and a distal end along a housing axis, the apparatus housing comprising at least three sides and having a finned outer surface and one or more channels disposed on an inner surface;
a fan connected to the proximal end of the housing, the fan configured to push air through the housing toward the distal end of the housing;
a venturi tube connected to the fan; and
an air distribution component disposed proximate the venturi tube, wherein the venturi tube is disposed between the fan and the air distribution element.

In a second embodiment, the apparatus according to the preceding wherein the air distribution component is cone-shaped, a pyramid, or a frustum of such shapes.

In a third embodiment, the apparatus according to the preceding embodiments, wherein the air distribution component side walls form with the central axis is between about 15 degrees and about 75 degrees.

In a fourth embodiment, the apparatus according to the preceding embodiments, wherein the air distribution component side walls form with the central axis is between from about 30 degrees to about 60 degrees.

In a fifth embodiment, the apparatus according to the preceding embodiments, wherein the air distribution component has a hole at which is either opened or closed at the top.

In a sixth embodiment, the apparatus according to the preceding embodiment, wherein the second opening diameter is less than the first opening diameter of the venturi tube.

In a seventh embodiment, the apparatus according to the preceding embodiments, wherein the size of first diameter opening of the venturi tube and the second diameter opening of the venture tube is dependent on the size of the overall cooling apparatus.

In an eighth embodiment, the apparatus according to the preceding embodiment, wherein the larger venturi tube opening has about a 145 mm pit that is narrowed down to between about 80 mm and about 114 mm for the inner venture tube.

In a ninth embodiment, the apparatus according to the preceding embodiments, wherein the cooling apparatus is made from aluminum or any other similar transition metal.

In a tenth embodiment, the apparatus according to the preceding embodiments, wherein the cooling apparatus partially or completely covers the electrical motor.

In an eleventh embodiment, wherein the fan distributes the air 360 degrees at and around the electric motor.

In a twelfth embodiment, the apparatus according to the preceding embodiments, wherein the cooling apparatus has a thermal conductivity of about 200 W/m·K.

In a thirteenth embodiment, the method according to the preceding embodiments, wherein the fan oscillates from about 20 degrees Celsius to about 55 degrees Celsius.

In a fourteenth embodiment, the apparatus according to the preceding embodiments, wherein the cooling apparatus is boltless.

In a fifteenth embodiment, the apparatus according to the preceding embodiments, wherein the cooling apparatus is not connected to the electric motor.

In a sixteenth embodiment, a method for preparing a boltless and finned metal body is disclosed which comprising:
placing the boltless and finned metal body around an electrical motor wherein the metal body includes:
a safety guard; an axial fan; an air cone; and an air tunnel;
further wherein each of the metal body parts are listed chronologically from an air intake to an air out let.

In a seventeenth embodiment, the method according to the preceding embodiment, wherein the electrical motor is a servomotor.

In an eighteenth embodiment, the method according to any of the preceding embodiments, wherein the boltless and finned metal body parts are made from aluminum or any other similar transition metal.

In a nineteenth embodiment, the method according to any of the preceding embodiments, wherein the boltless and finned metal body partially or completely covers the electrical motor.

In a twentieth embodiment, the method according to any of the preceding embodiments, wherein the finned metal body has a thermal conductivity of about 200 W/m·K.

In another embodiment, the method according to the preceding embodiments, wherein the axial fan is not connected to the electric motor.

In another embodiment, the apparatus or method according to the preceding embodiments wherein the temperature is maintained between about 55 degrees Celsius to about 75 degrees Celsius.

The above summary of the present disclosure is not intended to describe each embodiment or every implementation of the present disclosure. Advantages and attainments, together with a more complete understanding of the disclosure, will become apparent and appreciated by referring to the following detailed description and claims taken in conjunction with the accompanying drawings.

### BRIEF DESCRIPTION OF DRAWINGS

The disclosure may be more completely understood in consideration of the following detailed description of various embodiments in connection with the accompanying drawings, in which:

FIG. 1 is a top side view of the cooling apparatus; and

FIG. 2 is an internal perspective view of venturi tubes channeling air in a preferred direction.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the scope of the disclosure.

### DETAILED DESCRIPTION OF THE DISCLOSURE

Each example of this disclosure is provided by way of explanation and is not meant as a limitation. For example, features illustrated or described as part of one embodiment or figure can be used on another embodiment or figure to yield yet another embodiment. It is intended that the present disclosure include such modifications and variations.

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

When introducing elements of the present disclosure or the preferred embodiment(s) thereof, the articles “a”, “an”, and “the” are intended to mean that there are one or more of the elements.

The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

The term “apparatus” disclosed herein refers to a boltless and finned metal body and a motor wherein the motor may be partially or completely covered by the metal body. The boltless and finned metal body comprises a safety guard, axial fan, air cone and cooling fin.

The term “boltless and finned metal body” disclosed herein may be made from aluminum or any other similar transition metal.

The term “motor” or “electric motor” disclosed herein may be any type of motor such as a servomotor.

The term “fan” disclosed herein is a type of a compressor that increases the pressure of the air flowing through it. The blades of the fans force air to move parallel to the shaft about which the blades rotate. In other words, the flow is axially in and axially out, linearly. The design priorities in an axial fan revolve around the design of the propeller that creates the pressure difference and hence the suction force that retains the flow across the fan.

The axial fan used herein is a commercial fan which is optimized for using at low power spent, relatively high volume airflows. Axial fans are best suited for general purposes of cooling spaces with required low power input for operation. A low pressure with high volume airflows rapidly decrease the heated motor surface.

The term “Venturi effect” disclosed herein is the reduction in fluid pressure that results when a fluid flows through a constricted section such as a cone as disclosed herein.

Apparatus Housing

The current disclosure describes a cooling apparatus for improving the cooling of an electric motor and thereby increasing motor life span. In general, the cooling apparatus may comprise a housing that at least partially surrounds the electric motor. In at least some embodiments, the housing may be made from one or more metal materials, or other materials with high heat conductivity. The cooling apparatus may particular benefit when the heat conductivity of the housing is above 200 W/mK. Such materials may allow the housing to be effectively used as a heat sink to help excess heat from the motor and surrounding air.

Finned Outer Sides

Another feature of the current disclosure is the design of the surface body of the metal housing. The metal surface body housing is finned which allows for a high thermal conductivity where heat is passed through quickly. This type of advantageous design of the fins allows the air flow to further increase through the interior of the motor and thus amplifying the cooling effect by circulating the air through the motor surface uniformly. The finned outer sides provide greater surface area for increased radiation of heat away from the motor for more effective cooling. The fins more specifically may be made from Aluminum or any other similar metal.

Internal Channels

Another feature of the current disclosure are the internal channels. These channels are aligned with the flat portion of the motor casing. The channels help create a more laminar airflow proximate the motor casing, thereby increasing dissipation of heat from the casing to the air, and channeling the air out of the housing for better cooling.

Boltless Design

A further feature of the current disclosure is the boltless assembly of the Servo Air-Kool system. The boltless system design is not only easy to assemble and disassemble but it minimizes space and is easy to maintain. The system also has a low energy consumption utilizing an axial fan power of about 110 Volts. The system has a high cooling efficiency wherein the temperature can be consistently kept below 100 degrees Celsius. The boltless system is also silent when in operation and is dust free.

The assembly of the boltless Servo Air-Kool system is arranged in a manner beginning on an air intake side through the interior of the motor housing to the air outlet side, i.e. backside of the servomotor.

The order of where the cooling parts are placed in the motor housing is one feature for maintaining a steady temperature so as not to overheat the motor. By not overheating the motor, manufacturing downtown is reduced and the life of the motor is increased. In the current disclosure the steady temperature is at or below 100 degrees Celsius.

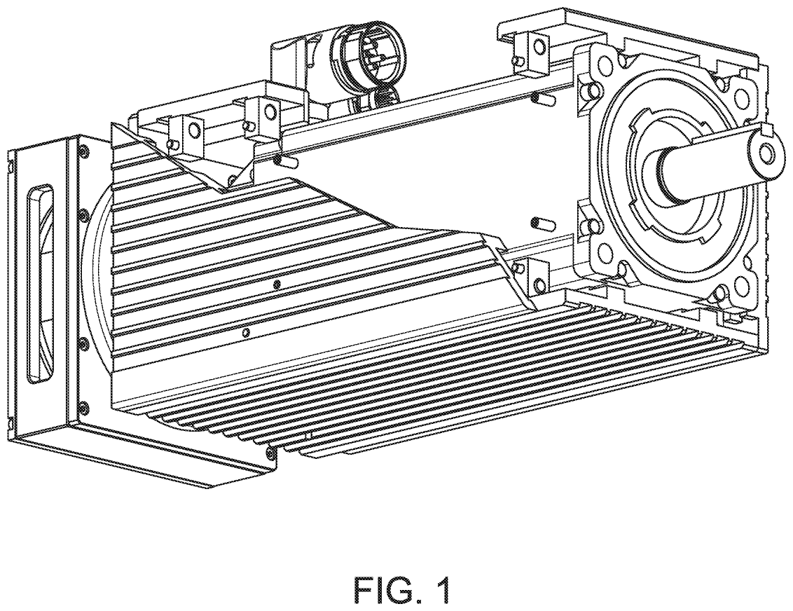

A further advantage of the design of the surface body of the metal housing is the internal geometry between the cooling fins and the motor housing parts. The contour of the cooling fins follow the contours of the motor housing in an axial direction preferably in such a way that between the fixed motor housing and the turning of the cooling fins there is as small as possible a clearance with a constant gap in order to catch the cooling air flow coming out of the interior of the motor housing as completely as possible and to increase the speed of flow as FIG. 1 shows an exemplary embodiment of the disclosed cooling system. The number of fins are about one 3 mm fin for every 10 mm of the metal plate. The fin angle and the number of fins is dependent on the plate length.

Fan

The cooling apparatus further comprises a fan (preferably axial) component coupled to the housing. FIG. 1 shows a boltless metal body arranged around a servomotor wherein the metal body has a finned contour. Ambient air is sucked into the housing through a safety guard by the axial fan. The air is pushed through the housing and beyond and past the motor, cooling the motor by convention.

In at least some embodiments, the fan is designed to have a diameter that is larger than a largest cross-sectional dimension of the motor. For instance, the fan diameter may be at least 10%, 15%, 20%, 25%, 30%, 35%, 50%, 60%, 75%, or 100% larger than the largest cross-sectional dimension of the motor. Where the cooling apparatus includes a venturi tube, this feature may provide for an even increased speed of airflow through the housing in comparison to a cooling apparatus that includes a small diameter fan.

Venturi Tube:

The cooling apparatus may further comprise a venturi tube connected to the fan and disposed between the fan and the motor.

The tube may have a first opening with a first opening diameter disposed proximate the fan and a second opening having a second opening diameter disposed proximate the motor, where the second opening diameter is less than the first opening diameter.

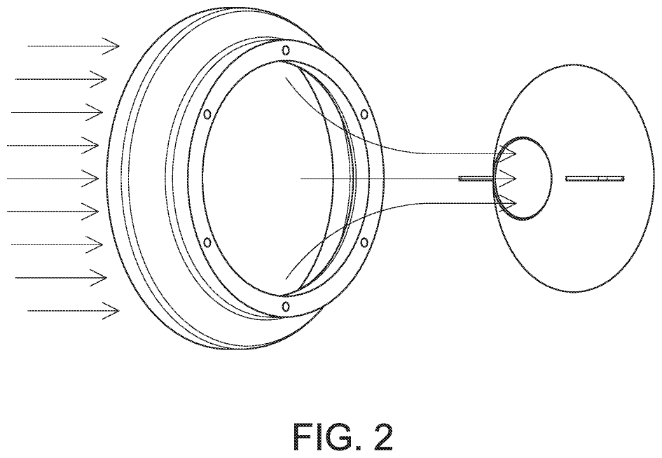

The size of first diameter opening versus the second diameter opening is dependent on the size of the overall servo air kool-housing. However, generally the larger inner tube opening has about a 145 mm pit that is narrowed down to between about 80 mm and about 114 mm for the inner sized tube. Please see FIG. 2.

FIG. 2 also depicts the air flow rate as the air is initially passed through the axial fan. The narrowing of the tube (from the first diameter opening to the second diameter opening) operates to speed up the air as it exits the second opening, thereby increasing the volume of air passing the motor per unit of time, helping to more effectively cool the motor.

Air Distribution Component

The cooling apparatus may further comprise an air distribution component configured to direct the air entering the portion of the housing containing the motor to flow in a relatively more laminar manner.

An air distribution component may extend between a first end and a second end along a central axis, with side walls which angle away from the central axis as they extend form the first end disposed proximate the venturi tube toward the second end disposed proximate the motor.

An air distribution component may comprise any suitable shape, such as a cone or a pyramid, or a frustum of such shapes.

The edges of the base of the cone of the second opening end of the air distribution component may optionally line up with the edges of the motor casing. The angles the side walls form with the central axis is between about 15 degrees and about 75 degrees and more preferably from about 30 degrees to about 60 degrees. The air distribution component may have a hole in the top (side closest to the axial fan) or may be closed.

Generally the assembly of the Servo Air-Kool system consists of an initial air intake side wherein first lies a safety guard where the guard is at least allows about 73% or more open area of air intake. An axial fan is placed directly thereafter the safety guard. Air is then fanned toward the motor at an air gap formed between the axial fan and a cone-shaped fan tube. The air flow here is generated by a difference in pressure which is created by the fan wheel driven by the electric motor between air inlet side and air outlet side. The design of the air cone distributes air coming from the Venturi tube around the motor. The Venturi tube is the part that narrows down the airflow stream. See FIG. 2. As the air is then passed from the air cone to an air tunnel and though an air outlet the entire housing surface is enclosed by the metal finned cooling body.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by references, the meaning or definition assigned to the term in this written document shall govern.

Those skilled in the art will recognize that the present disclosure may be manifested in a variety of forms other than the specific embodiments described and contemplated herein. Specifically, the various features described with respect to the various embodiments and figures should not be construed to be applicable to only those embodiments and/or figures. Rather, each described feature may be combined with any other feature in various contemplated embodiments, either with or without any of the other features described in conjunction with those features. Accordingly, departure in form and detail may be made without departing from the scope of the present disclosure as described in the appended claims.

What is claimed is:

1. A cooling apparatus configured to cool an electrical motor, the cooling apparatus comprising:
an apparatus housing extending between a proximal end and a distal end along a housing axis, the apparatus housing comprising at least three sides and having a finned outer surface and one or more channels disposed on an inner surface;
a fan connected to the proximal end of the housing, the fan configured to push air through the housing toward the distal end of the housing;
a venturi tube connected to the fan; and
an air distribution component disposed proximate the venturi tube, wherein the venturi tube is disposed between the fan and the air distribution element.

2. The apparatus according to claim 1, wherein the air distribution component is cone-shaped, a pyramid, or a frustum of such shapes.

3. The apparatus according to claim 1, wherein the air distribution component side walls form with the central axis is between about 15 degrees and about 75 degrees.

4. The apparatus according to claim 3, wherein the air distribution component side walls form with the central axis is between from about 30 degrees to about 60 degrees.

5. The apparatus according to claim 1, wherein the air distribution component has a hole at which is either opened or closed at the top.

6. The apparatus according to claim 1, wherein the second opening diameter is less than the first opening diameter of the venturi tube.

7. The apparatus according to claim 6, wherein the size of first diameter opening of the venturi tube and the second diameter opening of the venture tube is dependent on the size of the overall cooling apparatus.

8. The apparatus according to claim 7, wherein the larger venturi tube opening has about a 145 mm pit that is narrowed down to between about 80 mm and about 114 mm for the inner venture tube.

9. The apparatus according to claim 1, wherein the cooling apparatus is made from aluminum or any other similar transition metal.

10. The apparatus according to claim 1, wherein the cooling apparatus partially covers the electrical motor.

11. The apparatus according to claim 1, wherein the fan distributes the air 360 degrees at and around the electric motor.

12. The apparatus according to claim 1, wherein the cooling apparatus has a thermal conductivity of about 200 W/m·K.

13. The apparatus according to claim 1, wherein the fan oscillates from about 20 degrees Celsius to about 55 degrees Celsius.

14. The apparatus according to claim 1, wherein the cooling apparatus is boltless.

15. The apparatus according to claim 1, wherein the cooling apparatus is not connected to the electric motor.

16. A method for preparing a boltless and finned metal body comprising:
placing the boltless and finned metal body around an electrical motor wherein the metal body includes:
a safety guard; an axial fan; an air cone; and an air tunnel;
further wherein each of the metal body parts are listed chronologically from an air intake to an air out let.

17. The method according to claim 16, wherein the electrical motor is a servomotor.

18. The method according to claim 16, wherein the boltless and finned metal body parts are made from aluminum or any other similar transition metal.

19. The method according to claim 16, wherein the boltless and finned metal body partially or completely covers the electrical motor.

20. The method according to claim 16, wherein the finned metal body has a thermal conductivity of about 200 W/m·K.
